(19) United States
(12) Patent Application Publication
(10) Pub. No.: US 2022/0112062 A1
(43) Pub. Date: Apr. 14, 2022

(54) VEHICLE WITH AN AERIAL WORK PLATFORM

(71) Applicant: KABUSHIKI KAISHA AICHI CORPORATION, Saitama (JP)

(72) Inventor: Yuya WATANABE, Okegawa-shi (JP)

(73) Assignee: KABUSHIKI KAISHA AICHI CORPORATION, Saitama (JP)

(21) Appl. No.: 17/478,086

(22) Filed: Sep. 17, 2021

(30) Foreign Application Priority Data
Oct. 12, 2020 (JP) 2020-171634

(51) Int. Cl. B66F 11/04

(52) U.S. Cl. CPC B66F 11/046

(57) ABSTRACT

A vehicle with an aerial work platform comprises a traveling body 10, a boom 30 vertically swingable, a work platform 50 attached to the boom, and a parallel link mechanism 70 installed between the tip of the boom and the work platform. The parallel link mechanism comprises a boom side vertical link member 72 pivotably connected to the boom on a first connecting pivot axis, an upper horizontal link member 73 pivotably connected to the boom side vertical link member on the first connecting pivot axis, a work platform side vertical link member 71 pivotably connected to the upper horizontal link member on a second connecting pivot axis, a lower horizontal link member 74 pivotably connected to the boom side vertical link member on a third connecting pivot axis. The lower horizontal link member is pivotaly connected to the work platform side vertical link member on a fourth connecting pivot axis. The work platform is attached to the work platform side vertical link member, and a leveling cylinder attached to the the boom is pivotably connected to the boom side vertical link member and the lower horizontal link member on on the fourth connecting pivot axis.

### TECHNICAL FIELD

The present invention relates to a vehicle with an aerial work platform with a vertically swingable boom. The boom is provided on the vehicle body so that a work platform is supported swingably in the vertical direction by a parallel link mechanism at the tip of the boom.

### TECHNICAL BACKGROUND

A vehicle with an aerial work platform generally comprises a traveling body capable of traveling with a wheel or a crawler device, a turntable horizontally rotatable and provided on the traveling body, a boom vertically swingable and telescopic provided on the turntable, and a work platform capable of swinging supported on the tip of the boom. An operation device is provided on the work platform. The operator on the work platform can operates the operation device to control the rotating operation of the turntable, vertically swinging the boom, and horizontally swinging the work platform.

In working on an object at a high place using such a vehicle with an aerial work platform described above, the operator gets on the work platform together with the tool, the materials, and the like. The operator can move the work platform to the work object at a high place by operating the above-described operation device. At this time, a moment (hereinafter referred to as an “overturning moment”) to turn over the vehicle body toward the work platform is applied on the vehicle with an aerial work platform. This overturning moment increases due to an increase in movable load to the work platform, extension operation of the boom, and the like. Thus in some vehicles with an aerial work platform, for example, according to Japanese Laid-open Patent Publication No. H9 (1997)-67099, detecting the load on the work platform and preventing the operating range of the boom according to the detected load prevents the overturning moment that changes according to the operation of the boom from impairing the stability of the vehicle body.

In the vehicle with an aerial work platform according to the above-mentioned Japanese Laid-open Patent Publication No. H9 (1997)-67099, the bracket attached to the tip of the boom, the boss installed in the work platform, and the top link member and the lower link member are pivotably connected mutually to constitute a parallel link mechanism. With this parallel link mechanism, the work platform enables swinging in the vertical direction while keeping the floor horizontal. The load cell, arranged on the bottom surface of the boss, which is the movable part of the parallel link mechanism, detects the vertical load on the work platform.

In addition, a vertical post is pivotably connected to the tip of the boom to be swingable in the vertical direction. This vertical post pivots one end of an arm, having a long flat plate shape to swing in the horizontal direction. The other end of the arm pivotally supports a bracket constituting the parallel link mechanism by a pivot so as to be swingable in the horizontal direction. Further, the above-mentioned vertical post is pivotably connected to the tip of the leveling cylinder arranged on the boom and the other tip of the boom. The telescopic operation of the leveling cylinder enables leveling control such that the vertical post keeps vertical (and the work platform keeps horizontal) while the boom swings vertically.

### SUMMARY OF THE INVENTION

### Problems to be Solved by the Invention

By the way, the parallel link mechanism described above is composed of a bracket, a boss, an upper link member, and a lower link member. One pin each (four in total) pivotably connects the pivot of the bracket and the upper link member, the pivot of the upper link member and the boss, the pivot of the boss and the lower link member, and the pivot of the lower link member and the bracket. Also, one pin each (two in total) pivotably connects the pivot of the tip of the boom and the vertical post and the pivot of the vertical post and the tip of the leveling cylinder.

However, the pin for pivotably connecting each member of the parallel link mechanism and the pin for pivotably connecting the vertical post, the boom tip, and the leveling cylinder are all pivotably connecting a plurality of members. There is room to reduce pins for pivotably connecting each member and reduce the manufacturing cost by ingenuity.

The present invention has been made because of such a problem. The purpose of the invention is to provide a vehicle with an aerial work platform that can reduce the number of parts for attaching a work platform swingably supported in the vertical direction by a parallel link mechanism to the tip of a boom.

### Means to Solve the Problems

In order to solve the above problems, a vehicle with an aerial work platform according to the present invention comprises a vehicle body (e.g., the traveling body 10 in the embodiment), a boom (e.g., the boom 30 in the embodiment) mounted on the vehicle body and being vertically swingable, a work platform (e.g., the work platform 50 in the embodiment) attached to a tip of the boom and moved up and down by the boom, and a parallel link mechanism (e.g., the parallel link mechanism 70 in the embodiment) installed between the tip of the boom and the work platform. Wherein, the parallel link mechanism comprises; a boom side vertical link member (e.g., the boom side vertical link member 72 in the embodiment) pivotably connected to the tip of the boom on a first connecting pivot axis and extending vertically, an upper horizontal link member (e.g., the upper horizontal link member 73 in the embodiment) pivotably connected to the boom side vertical link member on the first connecting pivot axis and extends horizontally, a work platform side vertical link member (e.g., the work platform side vertical link member 71 in the embodiment) pivotably connected to the upper horizontal link member on a second connecting pivot axis horizontally apart from the first connecting pivot axis and extends vertically, a lower horizontal link member (e.g., the lower horizontal link member 74 in the embodiment) pivotably connected to the work platform side vertical link member on a third connecting pivot axis, which locates below the second connecting pivot axis, and extends horizontally, and the lower horizontal link member being pivotaly connected to the boom side vertical link member on a fourth connecting pivot axis, which locates below the first connecting pivot axis, the work platform is attached to the work platform side vertical link member, and a tip of a leveling cylinder (e.g., the leveling cylinder 37 in the embodiment) attached to the the boom is pivotably connected to the boom side vertical link member and the lower horizontal link member on on the fourth connecting pivot axis.

In the above-described vehicle with an aerial work platform, preferably the tip of the boom, the boom side vertical link member and the upper horizontal link member are mutually pivotally connected by a single pivot pin (e.g., the upper pivot pin 75 in the embodiment) on the first connecting pivot axis, and the tip of the leveling cylinder, the boom side vertical link member and the lower horizontal link member are mutually pivotally connected by another single pivot pin (e.g., the lower pivot pin 76 in the embodiment) on the fourth connecting pivot axis.

A vehicle with an aerial work platform according to another of the present invention comprises a vehicle body (e.g., the traveling body 10 in the embodiment), a boom (e.g., the boom 30 in the embodiment) mounted on the vehicle body and being vertically swingable, a parallel link type jib mechanism (e.g., the jib mechanism 40 in the embodiment) attached to a tip of the boom, a work platform (e.g., the work platform 50 in the embodiment) attached to a tip of the parallel link type jib mechanism and moved up and down by the boom, and a parallel link mechanism (e.g., the parallel link mechanism 70 in the embodiment) installed between the tip of the parallel link type jib mechanism and the work platform. Wherein, the parallel link mechanism comprises; a boom side vertical link member (e.g., the boom side vertical link member 72 in the embodiment) pivotably connected to a tip of an upper arm member (e.g., the upper arm member 41 in the embodiment) of the parallel link type jib mechanism on a first connecting pivot axis and extending vertically, an upper horizontal link member (e.g., the upper horizontal link member 73 in the embodiment) pivotably connected to the boom side vertical link member on the first connecting pivot axis and extends horizontally, a work platform side vertical link member (e.g., the work platform side vertical link member 71 in the embodiment) pivotably connected to the upper horizontal link member on a second connecting pivot axis horizontally apart from the first connecting pivot axis and extends vertically, a lower horizontal link member (e.g., the lower horizontal link member 74 in the embodiment) pivotably connected to the work platform side vertical link member on a third connecting pivot axis, which locates below the second connecting pivot axis, and extends horizontally, and the lower horizontal link member being pivotaly connected to the boom side vertical link member on a fourth connecting pivot axis, which locates below the first connecting pivot axis, the work platform is attached to the work platform side vertical link member, and a tip of a lower arm member (e.g., the lower arm member 42 in the embodiment) of of the parallel link type jib mechanism is pivotably connected to the boom side vertical link member and the lower horizontal link member on on the fourth connecting pivot axis.

In the above-described vehicle with an aerial work platform, preferably the tip of the boom, the boom side vertical link member and the upper horizontal link member are mutually pivotally connected by a single pivot pin (e.g., the upper pivot pin 75 in the embodiment) on the first connecting pivot axis, and the tip of the leveling cylinder, the boom side vertical link member and the lower horizontal link member are mutually pivotally connected by another single pivot pin (e.g., the lower pivot pin 76 in the embodiment) on the fourth connecting pivot axis.

The vehicle with an aerial work platform according to the invention as described above is preferably configured as follows. The parallel link mechanism allows the work platform to be movable up and down with respect to the boom side vertical link member. The work platform is equipped with a load detector (for example, load cell 80 in the embodiment), detecting the load in the vertical direction from the work platform side to the boom side. The load detector is sandwiched up and down between the boom side support formed at the boom side vertical link member (e.g., the, load cell support 72a in the embodiment) and the work platform side support (e.g., the, the work platform support 71a in the embodiment) formed at the work platform side vertical link member, in such a way to prevent the work platform from moving up and down.

Further, preferably on the vehicle with an aerial work platform configured as above, the work platform side vertical link member is provided with a vertical post member (e.g., the, vertical post 60 in the environment). The vertical post member supports the work platform in such a way to allow its horizontal swinging.

### Advantageous Effects of the Invention

In the vehicle with an aerial work platform according to the present invention, the boom side vertical link member, the upper horizontal link member, the work platform side vertical link member, and the lower horizontal link member constitute the parallel link mechanism installed between the tip of the boom (or the parallel link type jib mechanism) and the work platform. The boom side vertical link member is pivotably connected at the tip of the boom (or the upper arm member). The upper horizontal link member is pivotably connected on the same axis as the pivot. Further, the tip of the leveling cylinder (or lower arm member) attached to the tip of the boom is pivotably connected to the boom side vertical link member and the lower horizontal link member on the same axis as the pivot of the boom side vertical link member and the lower horizontal link member. As a result, it is possible to combine a pivot for constituting a parallel link mechanism (in particular, a pivot of boom side vertical link member and upper horizontal link member, and a pivot of boom side vertical link member and lower horizontal link member) and a pivot for pivotably connecting the parallel link mechanism to the boom tip and the tip of the leveling cylinder (or each tip of the upper arm member or the lower arm member). For this reason, for example, it is possible to reduce the number of members for pivotably connecting (for example, the pivot pin), compared to a case in which the pivot for constituting a parallel link mechanism and a pivot for pivotably connecting the parallel link mechanism to the boom or the parallel link type jib mechanism.

In the vehicle with an aerial work platform of constitution described above, the work platform should be movable up and down with respect to the boom side vertical link member by the parallel link mechanism. The work platform is equipped with a load detector, detecting the load in the vertical direction from the work platform side to the boom side. The load detector is sandwiched up and down between the boom side support formed at the boom side vertical link member and the work platform side support formed at the work platform side vertical link member in such a way to prevent the work platform from moving up and down. As a result, the moment due to vertical load to the work platform is offset by the moment of the product of the horizontal tensile force applied to the upper horizontal link member or the horizontal compressive force applied to the lower horizontal link member and the distance between the link members. Thus, the load detector can detect the vertical load applied from the work platform side to the boom side.

Further, in the vehicle with an aerial work platform of any one of the above-described constitution, preferably, a vertical post member is provided in the work platform side vertical link member, and the vertical post member supports the work platform so that the work platform can swing horizontally. As a result, the swinging operation of the work platform is possible in any of the above configurations of the vehicle with an aerial work platform.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 A side view showing the exterior of a vehicle with an aerial work platform related to the present invention.

FIG. 2 A side view showing the exterior of the jib mechanism and the work platform of the vehicle with an aerial work platform.

FIG. 3 A side view showing the exterior of the parallel link mechanism provided between the jib mechanism and the work platform of the vehicle with an aerial work platform.

FIG. 4 A perspective view showing the exterior of the parallel link mechanism provided between the jib mechanism and the work platform of the vehicle with an aerial work platform.

FIGS. 5A and 5B Side views showing the exterior of the parallel link mechanism and the work platform provided at the boom tip of the vehicle with an aerial work platform.

### DESCRIPTION OF THE EMBODIMENTS

Hereinafter, the embodiment of the present invention is described with reference to the drawings.

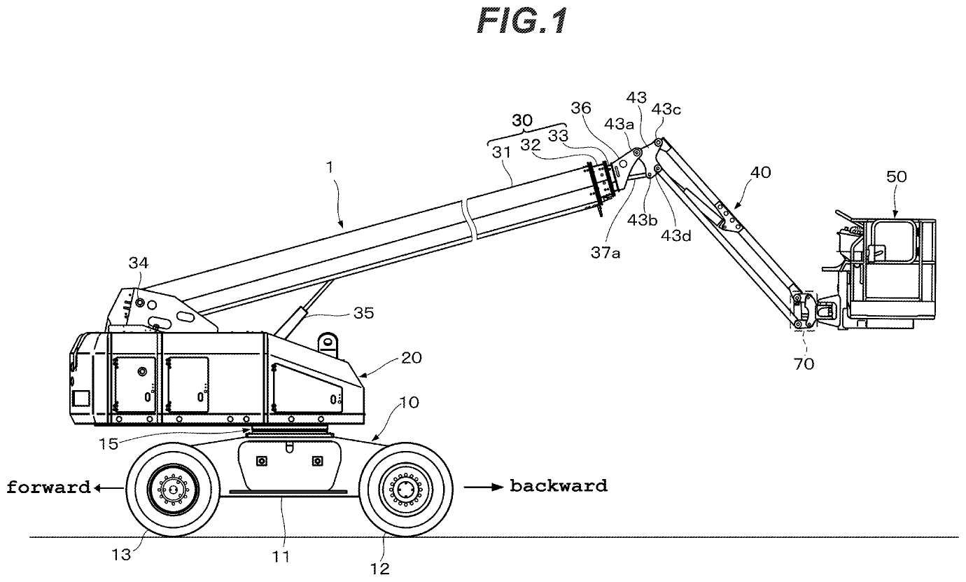

FIG. 1 shows a self-propelled vehicle with an work platform 1 as an example of a vehicle with an aerial work platform 1 related to the present invention. The vehicle with an aerial work platform 1 comprises the following: a traveling body 10, which is configured to be capable of traveling, a rotating body 20 provided at the top of the traveling body 10 and is rotatable in the horizontal direction, a vertically swingable boom 30 provided on the top of the rotating body 20, a jib mechanism 40 provided on the tip of the boom 30, and the work platform 50. In FIG. 1, the length of the boom 30 is partially omitted. Further, the left side of the page (drive wheels 13 sides) in FIG. 1 is defined as forward, and the right side of the page (steering wheels 12 sides) is defined as backward.

The traveling body 10 includes steering wheels 12 of the left and right pair and drive wheels 13 of the left and right pair, rotatably provided on the traveling body frame 11. The rotation mechanism 15 provided in the upper center of the traveling body frame 11 allows the rotating body 20 to rotate horizontally. The rotation mechanism 15 includes an outer ring fixed to the traveling body frame 11, an inner ring engaged with this outer ring and fixed to the rotating body 20, and a rotary center joint (not shown) for supplying hydraulic oil to various actuators on the traveling body 10. A boom 30 is provided on the top of the rotating body 20. The boom 30 is rotatable (vertically swingable) in the vertical direction around a pivot pin 34. The boom 30 has a base boom 31 pivotably connected to the rotating body 20, an intermediate boom 32, and a top boom 33 combined with the telescopic form to the base boom 31. These booms are configured for telescopic operation.

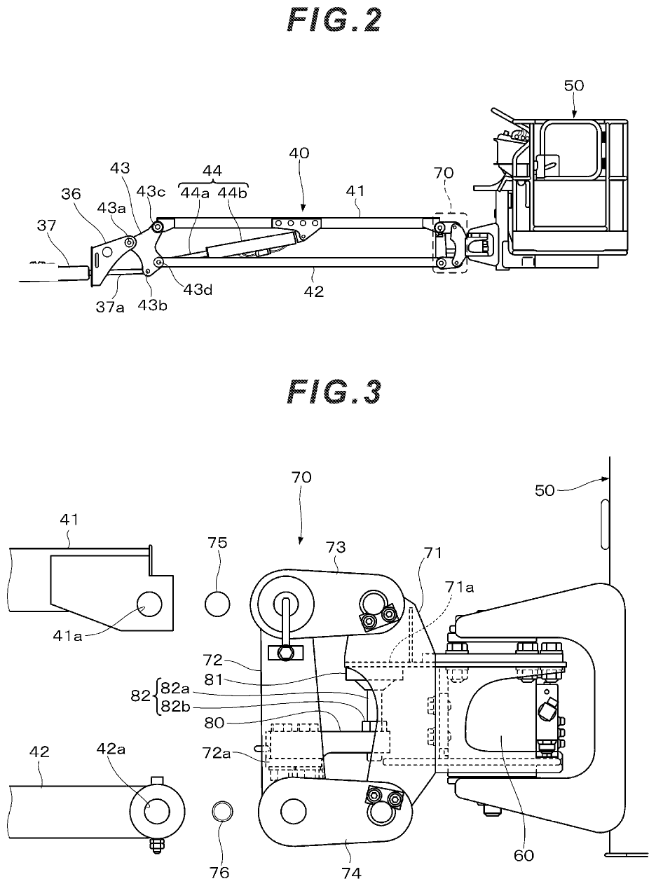

The boom head 36 at the tip of the top boom 33 is pivotably connected by a pivot pin 43a to the jib base 43, the base end of the parallel link type jib mechanism 40. The jib base 43 is pivotably connected by a pivot pin 43b to the piston rod 37a of the boom side leveling cylinder 37 (see FIG. 2), located inside the top boom 33. This allows the jib mechanism 40 to be vertically swingable with respect to the boom head 36 with the pivot pin 43a as the axis by the telescopic operation of the boom side leveling cylinder 37. The parallel link mechanism 70 is attached to the tip of the jib mechanism 40. The parallel link mechanism 70 supports the work platform 50 in such a way to be movable up and down. The work platform 50 is equipped with an operation device that enables the operator on the work platform 50 to control the travel of the traveling body 10, the rotating operation of the rotating body 20, the vertically swinging operation of the boom 30, and the swinging operation of the work platform 40.

Next, referring to FIG. 2, the configuration of the jib mechanism 40 is explained. The jib mechanism 40 mainly comprises a jib base 43, an upper arm member 41, and a lower arm member 42. The jib base 43 is pivotably connected to the tip of the boom head 36 and the tip of the cylinder rod 37a of the leveling cylinder 37 by the pivot pins 43a and 43b mentioned above and is also pivotably connected to one end of the horizontally extending long rod-shaped upper arm member 41 by the pivot pin 43c. Below the pivot pin 43c, the jib base 43 and one end of the long rod-shaped lower arm member 42, which extends almost parallel to the upper arm member 41, are pivotably connected by the pivot pin 43d. The other end of each of the upper arm member 41 and lower arm member 42 are pivotably connected to the parallel link mechanism 70.

A jib side cylinder 44 is provided between the upper arm member 41 and the lower arm member 42, and a tip of a piston rod 44a is pivotably connected together with the jib base 43 and the lower arm member 42 by a pivot pin 43d to the pivot point of the jib base 43 and the lower arm member 42. The base end of a cylinder tube 44b of the jib side cylinder 44 is pivotably connected to the upper arm member 41. This configuration enables telescopically operating the boom side leveling cylinder 37 in response to the vertically swinging of the boom 30, controlling the leveling of the work platform 50, and telescopically operating the jib side cylinder 44, thereby allowing vertical swinging of the work platform 50 relative to the tip of the boom 30 with the floor of the work platform 50 kept horizontal.

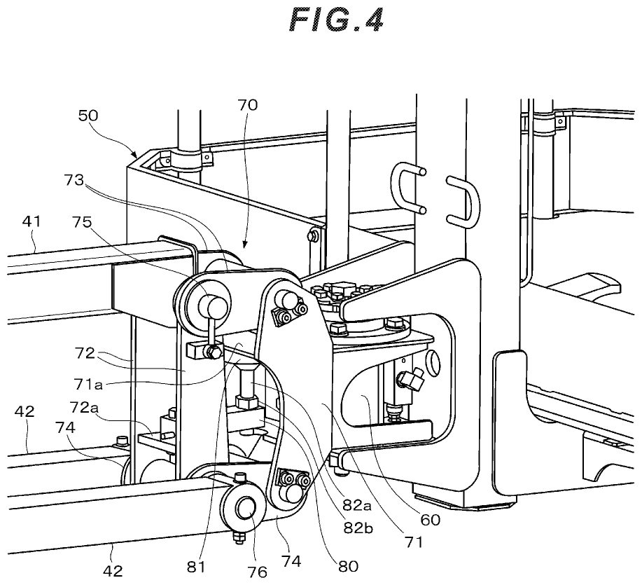

Next, FIGS. 3 and 4 explain the configuration of the parallel link mechanism 70 and its surroundings and the pivots of the parallel link mechanism 70, the upper arm member 41, and lower arm member 42. Here, FIG. 3 shows a side view of the parallel link mechanism 70 and its surrounding configuration. FIG. 4 shows a perspective view of the parallel link mechanism 70 and its surrounding configuration when viewed from slightly behind in the direction of the work platform 50. The parallel link mechanism 70 comprises a boom side vertical link member 72 that extends vertically and is located on the boom 30 side, a work platform side vertical link member 71 that extends vertically and is located on the work platform side, an upper horizontal link member 73 extending horizontally with one end pivotably connected to the boom side vertical link member 72 (the connecting axis thereof being called as “first connecting pivod axis”) and the other end pivotably connected to the work platform side vertical link member 71 (the connecting axis thereof being called as “second connecting pivod axis”), and a lower horizontal link member 74 extending horizontally below the upper horizontal link member 73 with one end pivotably connected to the boom side vertical link member 72 (the connecting axis thereof being called as “fourth connecting pivod axis”) and the other end pivotably connected to the work platform side vertical link member 71 (the connecting axis thereof being called as “third connecting pivod axis”). The boom side vertical link member 72, the work platform side vertical link member 71, the upper horizontal link member 73, and the lower horizontal link member 74 each comprise a set of two members, one at the back side of the page and the other at the front of the page in FIG. 3, arranged in opposite directions (see FIG. 4).

The parallel link mechanism 70 is connected to the tip of the jib mechanism 40 through the pivotable connection to the tip of the upper arm member 41 by the upper pivot pin 75 for pivotably connecting the upper horizontal link member 73 and the boom side vertical link member 72, and the pivotable connection to the tip of the lower arm member 42 by the lower pivot pin 76 for pivotably connecting the lower horizontal link member 74 and the boom side vertical link member 72. In more detail, the upper pivot pin 75 for pivotably connecting the upper horizontal link member 73 and the boom side vertical link member 72 penetrates the upper pinhole 41a (see FIG. 3) of the upper arm member 41. As a result, the upper arm member 41 is pivotably connected to the boom side vertical link member 72 and the upper horizontal link member 73 on the same axis as the pivot of the boom side vertical link member 72 and the upper horizontal link member 73. Similarly, the lower pivot pin 76 for pivotably connecting the lower horizontal link member 74 to the boom side vertical link member 72 penetrates the lower pinhole 42a (see FIG. 3) of the lower arm member 42. As a result, the lower arm member 42 is pivotably connected to the boom side vertical link member 72 and the lower horizontal link member 74 on the same axis as the pivot of the boom side vertical link member 72 and the lower horizontal link member 74.

As FIGS. 3 and 4 show, a work platform support 71a is formed between the two opposing work platform side vertical link members 71 to support the work platform 50. A vertical post 60 is fixed to this work platform support 71a. The vertical post 60 supports the work platform 50 swingable in the horizontal direction. A swing motor is installed inside the vertical post 60, enabling the swinging operation of the work platform 50. In addition, the work platform 50 can swing up and down against the tip of the jib mechanism 40 while keeping the floor level horizontally with the parallel link mechanism 70.

A load cell support 72a is formed between the two opposing boom side vertical link members 72. One end of a substantially rectangular load cell 80 is bolted to the top surface of the load cell support 72a. A load-bearing member 81 and a height adjusting member 82 are attached to the top surface side of the other end of the load cell 80. The load-bearing member 81 is a disc-shaped member that contacts the bottom surface of the work platform support 71a to receive the load on the work platform 50 side. The height adjusting member 82 comprises a bolt 82a fixed to the load-bearing member 81 and a nut 82b located on the top of the other end of the load cell 80. In load cell 80, at the position where the nut 82b is located, a through hole is provided through which the tip of the bolt 82a of the height adjusting member 82 can penetrate. As a result, rotating the load-bearing member 81 fixed to the bolt 82a of the height adjusting member 82 clockwise as viewed from the work platform support 71a side moves the contact surface of the load-bearing member 81 (in detail, the contact surface with the bottom surface of the work platform support 71a) downward (i.e., it is screwed into the load cell 80 side). Rotating it counterclockwise moves the contact surface of the load-bearing member 81 upward.

The above-mentioned configuration allows vertically sandwiching the load cell 80 between the load cell support 72a and the work platform side support 71a to prevent the vertical movement of the work platform 50, enabling the load cell 80 to detect the vertical load acting from the work platform 50 side to the boom 30 side.

Thus, in this embodiment, the pivot of the upper horizontal link member 73 and the boom side vertical link member 72, which constitute the parallel link mechanism 70, and the pivot for pivotably connecting the parallel link mechanism 70 to the upper arm member 41 of the jib mechanism 40, can be aligned on the same axis and pivotably connected by a single upper pivot pin 75. The pivot of the lower horizontal link member 74 and the boom side vertical link member 72 and the pivot for pivotably connecting the parallel link mechanism 70 to the lower arm member 42 of the jib mechanism 40 can be aligned on the same axis and pivotably connected by a single lower pivot pin 76. This arrangement reduces the number of pivot pins required to construct the parallel link mechanism and pivot the parallel link mechanism to the tip of the boom.

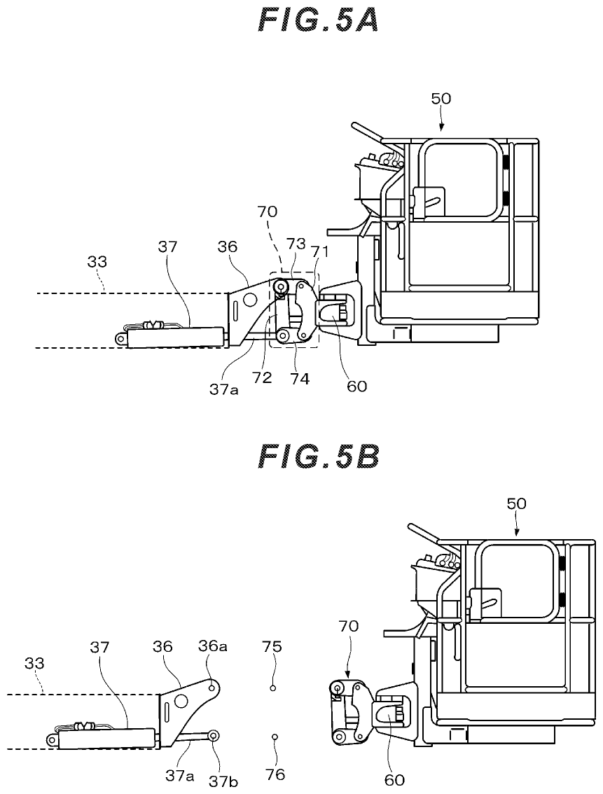

Next, a variation of this embodiment is described with reference to FIGS. 5A and 5B. In the above-mentioned embodiment, the jib mechanism 40 attached to the tip of the boom 30 is pivotably connected to the parallel link mechanism 70. In this variation, however, the parallel link mechanism 70 is directly pivotably connected to the tip of the boom 30. Here, FIG. 5A is a side view showing the parallel link mechanism 70 attached to the tip of the boom 30. FIG. 5B is a side view showing the parallel link mechanism 70 removed from the tip of the boom 30. In FIGS. 5A and 5B, configurations similar to the embodiment and shown in FIGS. 2 to 4 are marked with the same signs, and detailed explanations are omitted.

In this variation of the parallel link mechanism 70, the upper pivot pin 75 for pivotably connecting the upper horizontal link member 73 and the boom side vertical link member 72 penetrates an upper pinhole 36a (see FIG. 5B) in the boom head 36. This allows the boom head 36 to be pivotably connected to the boom side vertical link member 72 and the upper horizontal link member 73 on the same axis as the pivot of the boom side vertical link member 72 and the upper horizontal link member 73. Similarly, the lower pivot pin 76 for pivotably connecting the lower horizontal link member 74 and the boom side vertical link member 72 penetrates a lower pinhole 37b (see FIG. 5B) provided at the tip of the piston rod 37a of the boom side leveling cylinder 37. As a result, the piston rod 37a is pivotably connected to the boom side vertical link member 72 and the lower horizontal link member 74 on the same axis as the pivot of the boom side vertical link member 72 and the lower horizontal link member 74.

In the variant described above, the parallel link mechanism 70 (and thus the work platform 50) is swingable in the vertical direction with the upper pivot pin 75 as the axis. This configuration enables leveling control in which the floor surface of the work platform 50 is kept horizontal by the telescopic operation of the boom side leveling cylinder 37 in response to the vertically swinging operation of the boom 30.

Thus, in the variation described above, the pivot of the upper horizontal link member 73 and the boom side vertical link member 72, which constitute the parallel link mechanism 70, and the pivot for pivotably connecting the parallel link mechanism 70 with the boom head 36 can be aligned on the same axis and pivotably connected by one single upper pivot pin 75. The pivot of the lower horizontal link member 74 and the boom side vertical link member 72, and the pivot for pivotably connecting the parallel link mechanism 70 to the tip of the cylinder rod 37a of the boom side leveling cylinder 37 can be aligned on the same axis and pivotably connected by one single lower pivot pin 76. This configuration reduces the number of pivot pins required to construct the parallel link mechanism and pivotably connect the parallel link mechanism to the tip of the boom.

The present invention is not limited to the above embodiments and variations and can be improved as appropriate to the extent that it does not deviate from the gist of the present invention. For example, in this embodiment, the work platform 50 is pivotably attached to the vertical post 60 so as to be swingable. The vertical post 60 is provided to the work platform support 71a of the work platform side vertical link member 71. However, the vertical post 60 may be omitted, and the work platform 50 may be provided directly to the work platform support 71a. This embodiment is a self-propelled vehicle with an aerial work platform in which the operator controls the travel of the traveling body from the operation device installed on the work platform. However, it may also be a vehicle with an aerial work platform in which a turntable is provided on the vehicle body of a cab-over truck, including a boom with a work platform at its tip, vertically swingable, and installed on the turntable. In this embodiment, the traveling body is a vehicle with an aerial work platform that is a tire-wheel type, but the traveling body is not necessarily limited to a tire-wheel type but may travel by a crawler device, or the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This invention claims the benefit of Japanese Patent Application No. 2020-171634 which is hereby incorporated by reference.

1. A vehicle with an aerial work platform comprising; a vehicle body, a boom mounted on the vehicle body and being vertically swingable, a work platform attached to a tip of the boom and moved up and down by the boom, and a parallel link mechanism installed between the tip of the boom and the work platform, wherein
the parallel link mechanism comprises;
a boom side vertical link member pivotably connected to the tip of the boom on a first connecting pivot axis and extending vertically,
an upper horizontal link member pivotably connected to the boom side vertical link member on the first connecting pivot axis and extends horizontally,
a work platform side vertical link member pivotably connected to the upper horizontal link member on a second connecting pivot axis horizontally apart from the first connecting pivot axis and extends vertically,
a lower horizontal link member pivotably connected to the work platform side vertical link member on a third connecting pivot axis, which locates below the second connecting pivot axis, and extends horizontally, and
the lower horizontal link member being pivotaly connected to the boom side vertical link member on a fourth connecting pivot axis, which locates below the first connecting pivot axis,
the work platform is attached to the work platform side vertical link member, and
a tip of a leveling cylinder attached to the the boom is pivotably connected to the boom side vertical link member and the lower horizontal link member on on the fourth connecting pivot axis.

2. The vehicle with an aerial work platform according to claim 1 characterized in that:
the tip of the boom, the boom side vertical link member and the upper horizontal link member are mutually pivotally connected by a single pivot pin on the first connecting pivot axis, and
the tip of the leveling cylinder, the boom side vertical link member and the lower horizontal link member are mutually pivotally connected by another single pivot pin on the fourth connecting pivot axis.

3. The vehicle with an aerial work platform according to claim 1, characterized in that;
the parallel link mechanism allows the work platform to move up and down with respect to the boom side vertical link member,
a load detecting device to detect a vertical load acting from the work platform to the boom is provided, wherein the load detecting device is vertically sandwiched between a boom side support formed on the boom side vertical link member and a work platform side support formed on the work platform side vertical link member to prevent vertical movement of the work platform.

4. The vehicle with an aerial work platform according to claim 1, characterized in that;
a vertical post member is provided on the work platform side vertical link member, and the vertical post member pivotably supports the work platform to be horizontally swingable.

5. A vehicle with an aerial work platform comprising; a vehicle body, a boom mounted on the vehicle body and being vertically swingable, a parallel link type jib mechanism attached to a tip of the boom, a work platform attached to a tip of the parallel link type jib mechanism and moved up and down by the boom, and a parallel link mechanism installed between the tip of the parallel link type jib mechanism and the work platform, wherein
the parallel link mechanism comprises;
a boom side vertical link member pivotably connected to a tip of an upper arm member of of the parallel link type jib mechanism on a first connecting pivot axis and extending vertically,
an upper horizontal link member pivotably connected to the boom side vertical link member on the first connecting pivot axis and extends horizontally,
a work platform side vertical link member pivotably connected to the upper horizontal link member on a second connecting pivot axis horizontally apart from the first connecting pivot axis and extends vertically,
a lower horizontal link member pivotably connected to the work platform side vertical link member on a third connecting pivot axis, which locates below the second connecting pivot axis, and extends horizontally, and
the lower horizontal link member being pivotaly connected to the boom side vertical link member on a fourth connecting pivot axis, which locates below the first connecting pivot axis,
the work platform is attached to the work platform side vertical link member, and
a tip of a lower arm member of of the parallel link type jib mechanism is pivotably connected to the boom side vertical link member and the lower horizontal link member on on the fourth connecting pivot axis.

6. The vehicle with an aerial work platform according to claim 5 characterized in that:
the tip of the upper arm member of of the parallel link type jib mechanism, the boom side vertical link member and the upper horizontal link member are mutually pivotally connected by a single pivot pin on the first connecting pivot axis, and
the tip of the lower arm member of of the parallel link type jib mechanism, the boom side vertical link member and the lower horizontal link member are mutually pivotally connected by another single pivot pin on the fourth connecting pivot axis.

7. The vehicle with an aerial work platform according to claim 5, characterized in that;
the parallel link mechanism allows the work platform to move up and down with respect to the boom side vertical link member,
a load detecting device to detect a vertical load acting from the work platform to the boom is provided, wherein the load detecting device is vertically sandwiched between a boom side support formed on the boom side vertical link member and a work platform side support formed on the work platform side vertical link member to prevent vertical movement of the work platform.

8. The vehicle with an aerial work platform according to claim 5, characterized in that;
a vertical post member is provided on the work platform side vertical link member, and the vertical post member pivotably supports the work platform to be horizontally swingable.
